(19) United States
(12) Patent Application Publication
(10) Pub. No.: US 2002/0152070 A1
(43) Pub. Date: Oct. 17, 2002

(54) Electronic system, and method for identifying an authorized user and program therefor

(75) Inventor: Toshiaki Oda, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/117,198

(22) Filed: Apr. 8, 2002

(30) Foreign Application Priority Data
Apr. 13, 2001 (JP) 2001-115910

(51) Int. Cl. G10L 15/00

(52) U.S. Cl. 704/246

(57) ABSTRACT

An electronic system according to this invention comprises a means for registering a set of one or more keywords and passwords which correspond one to one with each other; a selection means for selecting any arbitrary pair of keyword and password from among the registered set of keywords and passwords; a display means for displaying the selected keyword; a means for identifying voice fed from outside of the electronic system, using a voice recognition means; and a means for determining based on comparison with the identification result whether the voice input corresponds with the password paired with the displayed keyword, wherein, when it is confirmed as a result of said comparison process that the voice input corresponds with the password, a user that has fed the voice input is approved as an authorized user of the electronic system.

### BACKGROUND OF THE INVENTION

1. Field of the Invention

The present invention relates to an electronic system which identifies an authorized user using its voice recognition function, and a method for identifying an authorized user, and program therefor.

2. Description of Related Art

With the recent expanded spread of cell phone terminals, concerns have emerged-as to the risk of terminals which have been lost or stolen being used in an unauthorized manner, or of personal information (privacy) being unduly leaked. In order to prevent such unauthorized use of terminals, some of current terminals are equipped such that, whenever an authorized user uses the terminal, he/she enters his/her previously registered password using keys on the terminal, thereby allowing the terminal to identify the user.

The related art for preventing the unauthorized use of cell phone terminals proposed to date includes, for example, a communication system described in Japanese Patent Laid-Open No. 9-84128 (published on Mar. 28 1997), and an unauthorized use prevention system described in Japanese Patent Laid-Open No. 8-84190 (published on Mar. 26 1996). Of them, the Japanese Patent Laid-Open No. 9-84128 discloses a technique whereby a communication system having a voice recognition function can analyze the voice of a user into a parameter while the user is talking on the line, and compare the parameter with those of authorized users previously registered and stored, and determine whether the user under study is authorized in the use of the system or not.

The unauthorized use prevention system described in Japanese Patent Laid-Open No. 8-84190 is based on a method comprising storing, as an authorized user identification database, a plurality of cipher voice data or voice prints sampled for the identification of authorized users, and, whenever it receives a call from a user, it asks the user to pronounce a specified keyword it selects from the database, and compares the voice input with the cipher voice data or voice prints stored as above, and, when it finds the input does not give a sufficient match, it determines the unauthorized use of an identification signal has been tried.

FIG. 1 is a block diagram to show an exemplary constitution of a conventional communication system. The system shown in the figure compares a token number entered via a keyboard 706 with an authorized token number registered in advance, and, when it finds the two are in agreement, releases a dial lock, to be ready for receiving a call and connecting the line with a desired destination.

A memory 710 of the system stores in advance coded parameters obtained by analyzing the voice of authorized users. A voice parameter comparing circuit 711, subsequent to the comparison of the two token numbers, analyzes the voice of the current caller during his/her call, into coded parameters, and compares the thus obtained parameters with the parameters stored in the memory 710, and, when it can not find, among the stored parameters, one that gives a sufficient match, in a specified time, it interrupts the line.

These prior arts have, however, following problems. If the cell phone terminal must determine whether a current user is authorized or not, after having received information (password) fed via the terminal, as is usual with current cell phone terminals, it must force the user to make a complicated manipulation before it allows the user to make a call. This inevitably forces the user to enter via keyboard an input comprising a plurality of numerals.

To ease the manipulation involved in the input feeding via keyboard, if the system adopts a password comprising only a few characters, then the password, because of its shortness, will be easily deciphered by other persons, and unauthorized use of the password will not be effectively prevented.

With both of the prior arts described in Japanese Patent Laid-Open Nos. 9-84128 and 8-84190, previous registration by the authorized users (speakers) of their voice information (cipher voice data or voice prints for user identification with the art of Japanese Patent Laid-Open No. 8-84190, and coded parameters deduced from the voice of authorized users with the art of Japanese Patent Laid-Open No. 9-84128) is essential for the prevention of unauthorized use of the system. The registration is not only burdensome to the user, and complicated, but also requires a large volume of data. The mode itself on which voice data required for the identification of authorized users should be registered in advance will cause the system to be complicated and enlarged.

This invention was proposed in view of the above problems, and aims at providing an electronic system and method for identifying an authorized user comprising identifying an authorized user based on the voice fed as input while strictly keeping secret the identification process.

Another object of this invention is to provide an electronic system and method for identifying an authorized user, comprising identifying an authorized user through an easy and simple procedure, while securely keeping secret the identification process regardless of whether the voice recognition concerns with the identification of the user or not.

### SUMMARY OF THE INVENTION

To attain the above objects, the electronic system according to this invention comprises a registration means for registering a set of one or more keywords and passwords which correspond one to one with each other; selection means for arbitrarily selecting a pair of keyword and password from among the registered set of keywords and passwords; display means for displaying the selected keyword; voice recognition means for extracting a characteristic of voice fed from outside of the electronic system, using a voice recognition function; and comparison means for determining whether the characteristic extracted from the voice through voice recognition function corresponds with that of the password initially registered and paired with the displayed keyword, wherein, when the system finds the characteristic under study is in agreement with that of the initially registered password, it admits the current user that has fed the voice is an authorized user of the electronic system.

Preferably, the selection means arbitrarily selects one or more pairs of keyword and password from the set of keywords and passwords previously registered.

The electronic system according to this invention is preferably further provided with a means for generating a random number, and the selection means selects one or more pairs of keyword and password, according to the random number.

More preferably, the voice recognition means effects an identifying voice recognition when some selected keywords, out of the set of plural keywords and passwords, are displayed, while it effects a non-identifying voice recognition when the other keywords are displayed.

Another aspect of this invention concerns with a method by which it is possible for an electronic system equipped with a voice recognition function to identify an authorized user of the system. The method comprises the steps of registering one or more keywords and passwords which correspond one to one with each other; arbitrarily selecting a pair of keyword and password from the registered set of keywords and passwords; displaying the keyword of the selected pair; extracting a characteristic from voice fed from outside of the electronic system, using a voice recognition function; comparing the characteristic obtained through the voice recognition step with that of the password initially registered and paired with the displayed keyword; and admitting, when it is confirmed that the characteristic under study is in agreement with that of the initially registered password, that the current user that has fed the voice is an authorized user of the electronic system.

Preferably, the selection step comprises arbitrarily selecting one or more pairs of keyword and password-from the set of keywords and passwords previously registered.

The method according to another aspect of this invention for identifying an authorized user is preferably further provided with a step of generating a random number, and the selection step comprises selecting one or more pairs of keyword and password, according to the random number.

A still other aspect of this invention concerns with a program for identifying an authorized user to be applicable to an electronic system equipped with a voice recognition function, the program comprising the processes of registering one or more keywords and passwords which correspond one to one with each other; arbitrarily selecting a pair of keyword and password from the registered set of keywords and passwords; displaying the keyword of the selected pair; extracting a characteristic from voice fed from outside of the electronic system, using a voice recognition function; comparing the characteristic obtained through the voice recognition process with that of the password initially registered and paired with the displayed keyword; and admitting, when it is confirmed that the characteristic under study is in agreement with that of the initially registered password, that the current user that has fed the voice is an authorized user of the electronic system.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram to show an exemplary constitution of a conventional communication system;

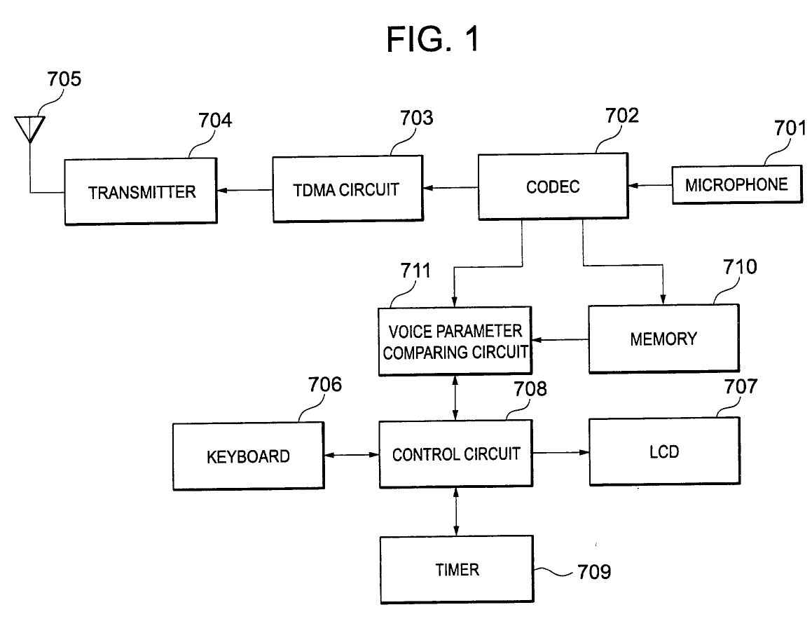

FIG. 2 is a block diagram to show the constitution of main components of a cell phone terminal representing a first embodiment of this invention;

FIG. 3 is a flow chart to show the procedures the cell phone terminal representing the first embodiment will take when the terminal must determine, for a given user, whether he/she is an authorized user, using its voice recognition function;

FIG. 4 is a diagram to schematically show the manner how a pair of keyword and password is selected from a memory portion where a set of plural keywords and passwords have been registered;

FIG. 5 is a flow chart to show the procedures a cell phone terminal representing a second embodiment of this invention will take when the terminal must determine, for a given user, whether he/she is an authorized user, using its voice recognition function;

FIG. 6 is a diagram to schematically show the manner how N pairs of keyword and password are selected from a set of plural keywords and passwords registered in the memory portion; and

FIG. 7 is a flow chart to show the relationship between the general actions of a cell phone terminal and operations for user identification.

### DETAILED DESCRIPTION OF THE PREFERRED EMBODIMENTS

The preferred embodiments of this invention will be detailed below with reference to the accompanying drawings. It should be noted, in the following description of the preferred embodiments, the operation of a cell phone system will be dealt with as a representative of the electronic system.

[First Embodiment]

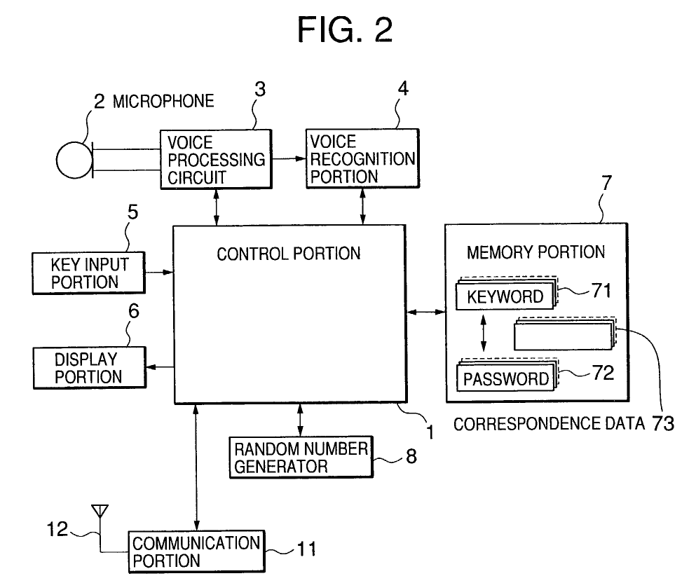

FIG. 2 is a block diagram to show the constitution of main components of a cell phone terminal representing a first embodiment of this invention. With the cell phone terminal shown in the figure (to be referred to simply as terminal hereinafter as needed), a control portion 1 controls this cell phone terminal at large. This portion comprises, for example, a central processing unit (CPU) consisting of a microprocessor, and may gain access to various components described later as needed.

A microphone 2 transforms voice fed from outside of this terminal into an electric signal, and transmits the signal subsequent to the transformation to a voice processing portion 3. The voice processing portion 3 comprises, for example, a coder/decoder (CODEC) and converts the voice signal transmitted from microphone 2 into a digital signal. A voice recognition portion 4 performs a voice recognition operation as specified later on the voice data in the form of a digital signal obtained through conversion at the voice processing portion 3.

A key input portion 5 contains function keys and ten keys (not illustrated) arranged on the terminal, and senses, whenever a user presses any desired one of those keys, a certain key being depressed, and informs the control portion 1 of the result. A display portion 6 makes any desired characters or images visible under the instruction of control portion 1, and comprises, for example, a liquid crystal display (LCD) device.

A memory portion 7 stores keywords 71, passwords 72 and correspondence data 73 (which will be described later) which concern with the correspondence between keywords and passwords, and delivers the stored content as needed. With this embodiment, control portion 1 gains access to memory portion 7, thereby reading data from the latter or writing data into the latter. A random number generator 8 generates a random number under the instruction of control portion 1, and informs control portion 1 of the number.

A communication portion 11 comprises a transmitter/receiver and frequency modulator (not illustrated) for allowing the cell phone terminal to achieve radio communication. To put it specifically, an electric signal received via an antenna is processed by communication portion 11, and then transmitted to control portion 1. A voice signal from microphone 2 or coded character information is radiated via communication portion 11 from antenna 12 into air. The modulation mode of the cell phone terminal is not directly related with the technique of this invention, and thus modulation may occur either on a digital mode or on an analog mode.

Operation required for the identification of an authorized user which will be described later is achieved by control portion 1 in accordance with a program stored in a non-volatile memory not illustrated (such as a read only memory (ROM)).

The cell phone terminal representing a first embodiment of this invention is characterized in that it determines whether a given user is authorized or not, based on voice fed via microphone 2. To attain this, the cell phone terminal stores in advance a plurality of keywords, and passwords which correspond with the keywords in a one-to-one manner.

Whenever user identification is required, the terminal randomly selects a pair of keyword and password from the set of keywords and passwords previously registered, and asks the user to utter (to speak aloud as in ordinary conversation) a password to be paired with the keyword on display, and extracts a character from the voice. The terminal compares the character with that of the password initially registered, and determines whether the user having given the voice is the same with the one that gave the registered password (i.e., the true user of this cell phone terminal).

The set of plural keywords and passwords is registered in advance into the memory (or memory portion 7 of this embodiment) of the terminal by, for example, an authorized user. For this purpose, the user may choose any desired words (no limitation is imposed on the number of letters contained in the word as long as the user can safely keep the word in mind) that are meaningful only to the user, or chosen in accordance with his/her characteristic concept. Thus, the keyword and password may contain any words including, for example, those related with personal data, simple numbers or characters, or simple words. The registration procedure as mentioned above ensures the strict secrecy of the-relationship between the keyword and the password.

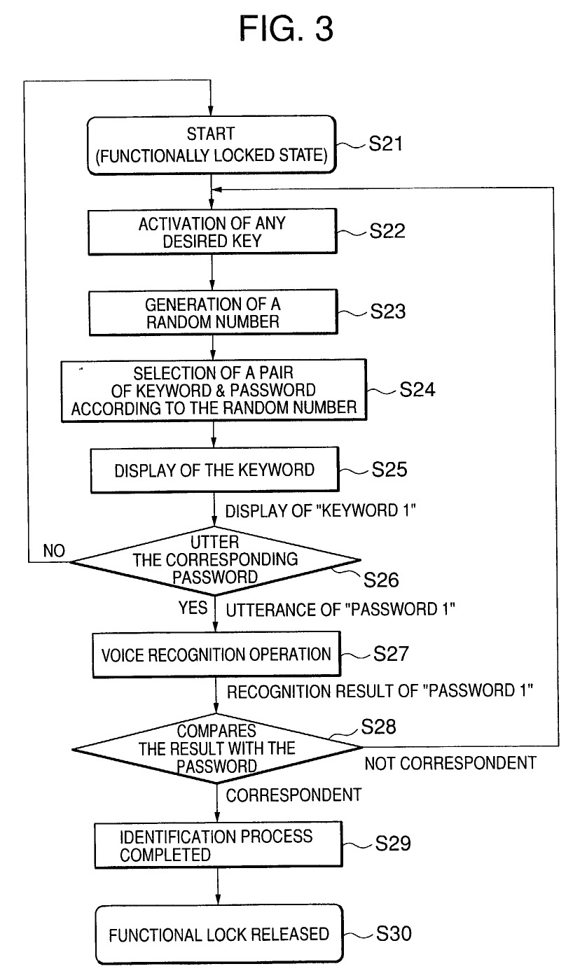

The procedures the cell phone terminal representing the first embodiment of this invention will take for determining of a given user whether he/she is an authorized user, will be described in detail below. FIG. 3 is a flow chart to show the procedures the cell phone terminal representing the first embodiment will take when the terminal is required to determine, for a given user, whether he/she is an authorized user, using its voice recognition function. The cell phone terminal has been locked when it initially receives a call from a user, and as long as the terminal being at this state, the user can not exploit any functions the terminal can offer (the terminal is at a “functionally locked state” as indicated in step S21 of FIG. 3).

While the cell phone terminal is at a functionally locked state, a user presses any desired key of key input portion 5, with an intention to use the terminal, and then the key input portion 5 informs control portion 1 of its sensing a certain key being depressed (step S22). On receipt of the information, control portion 1 transmits a specified start signal to the random number generator 8. As a consequence, control portion 1 receives a value (random number) generated by the random number generator 8 (step S23).

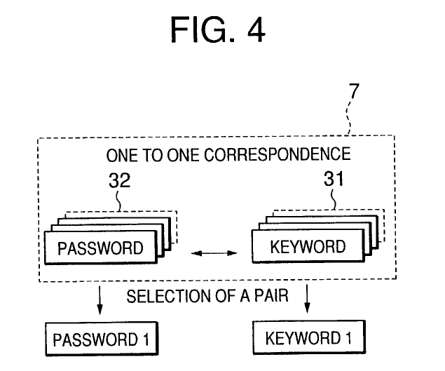

Next, at step S24, control portion 1 selects a pair of keyword and password, for example, “keyword 1” and “password 1” according to the random number from among the set of plural keywords and passwords registered in advance in memory portion 7. FIG. 4 is a diagram to schematically show the manner how a pair of keyword and password (in this particular example, “keyword 1” and “password 1”) is selected from the set of plural keywords and passwords registered in advance in memory portion 7.

As shown in FIG. 4, keywords 31 and passwords 32 are stored in memory portion 7 in a one-to-one corresponding manner, and control portion 1 selects, from among those keywords and passwords, a pair of keyword and password according to the random number generated by the random number generator 8.

After having selected a pair of keyword and password as above, control portion 1 instructs the display portion 6 to display only the keyword or one of the pair (or “keyword 1” in this particular example) in the form of a string of characters, to make it visible and legible to the user. This display prompts the user to pronunciate the password paired with “keyword 1.”

Then, at step S26, control portion 1 determines whether the user gave a required pronunciation (specifically, pronunciation of the password paired with the keyword), being prompted with the display of “keyword 1” as mentioned above. On the part of the user, he/she reminds him/herself of “password 1” paired with “keyword 1,” and says it aloud.

When the user gives a voice response, the response is captured by microphone 2, and transmitted as a voice signal to the voice processing portion 3 where it is converted into a digital signal, to be fed into the voice recognition portion 4. On receipt of the digital signal, the voice recognition portion 4 performs a specified voice recognition operation on the signal, and executes an operation necessary for converting the voice fed by the user into a code (step S27).

If control portion 1 determines the user gives no voice response at step S26, the process returns to the first step, and the cell phone terminal enters anew into a “functionally locked state” to remain there.

The user's voice input converted into a code by the voice recognition portion 4 at step S27, is used at the subsequent step S28 for determining whether it gives a match with the registered code of “password 1” selected at step S24. If the current voice recognition result gives a sufficient match with the registered code of “password 1,” control portion 1 determines the call is made from an authorized user of the terminal. Then, at step S29, control portion 1 completes the process for user confirmation (identification).

Based on the result obtained through the process introduced for identifying the user and for completing the user identification (steps S27 to S29), control portion 1 determines the cell phone terminal receives a call from an authorized user, and releases the functional lock of the terminal at step S30, thereby allowing the user to exploit the normally available functions of the terminal.

However, if control portion 1 determines that the voice recognition result does not give a sufficient match with the registered code of “password 1,” after having compared the former with the latter at step S28, the process returns to step S22, and waits until the user presses anew any desired key (key operation). This sequence of steps is introduced not-only because of preventing the unauthorized use of the terminal, but because, in case an authorized user happens to forget the password, or give a wrong password, of giving a renewed chance for the user to remember the right password.

As described above, according to the first embodiment, out of a pair of keyword and password randomly selected from multiple pairs of keyword and password previously registered, only the keyword is presented on the display portion, and the terminal asks the user to give the password paired with the keyword by saying it aloud, and then characterizes the voice input. Then, the terminal compares the characteristic of the password currently given as voice with that of the password initially registered in conjunction with the keyword on display, to determine whether the two are the same or not. This allows the terminal to securely determine whether a given user is authorized or not, by resorting to simple procedures.

Further, if the user identification method of this invention is introduced into a cell phone terminal having a voice recognition function, it will be possible to achieve user identification without requiring additional hardware, i.e., at a low cost and on a simple structure.

More specifically, the user identification method of the first embodiment will be advantageous in many respects: the method may be put into practice by any voice recognition function per se that is recently provided to an increasingly large number of cell phone terminals; the method will relieve the user of a burden involved in the complicated keyboard operation required for the entry of a password necessary for user identification; and, if the method is applicable to a current cell phone terminal, it will be possible to determine whether a given user is authorized or not, without requiring any large modification of its hardware or software.

Because a pair of keyword and password is selected based on a random number from among multiple pairs of keyword and password previously registered to be used for user identification, it is possible to make the prediction of the password more difficult, and to effect user identification more safely and securely, keeping its secrecy more strictly than is possible with the prior art.

Accordingly, the user identification method represented in the present embodiment can obviate the need for the previous registration of personal identification data based on the voice input by the user, and thus imposes a far less burden on the user than does the conventional method requiring such voice input for user identification, which will enable the terminal to be freed from the necessity of having a large volume of memory which would be otherwise required. This will be a great advantage to the, cell phone terminal for which smallness and lightness are the absolute requirement.

[Second Embodiment]

A second embodiment of this invention will be described below. Because the cell phone terminal representing the second embodiment is the same in constitution with that of the first embodiment shown in FIG. 2, illustration and description of the constitution thereof will be omitted.

The feature of the cell phone terminal representing the second embodiment comprises randomly selecting, whenever user identification operation is started, a number of pairs of keyword and password from among plural keywords and passwords previously registered which correspond one to one with each other; instructing a display portion to display the keywords thus selected sequentially in order; prompting thereby a user to utter the passwords paired with the keywords; extracting characteristics from the user's voice inputs; comparing the characteristics with those of the previously registered passwords; and determining based on the comparison result whether the user is an authorized user or not.

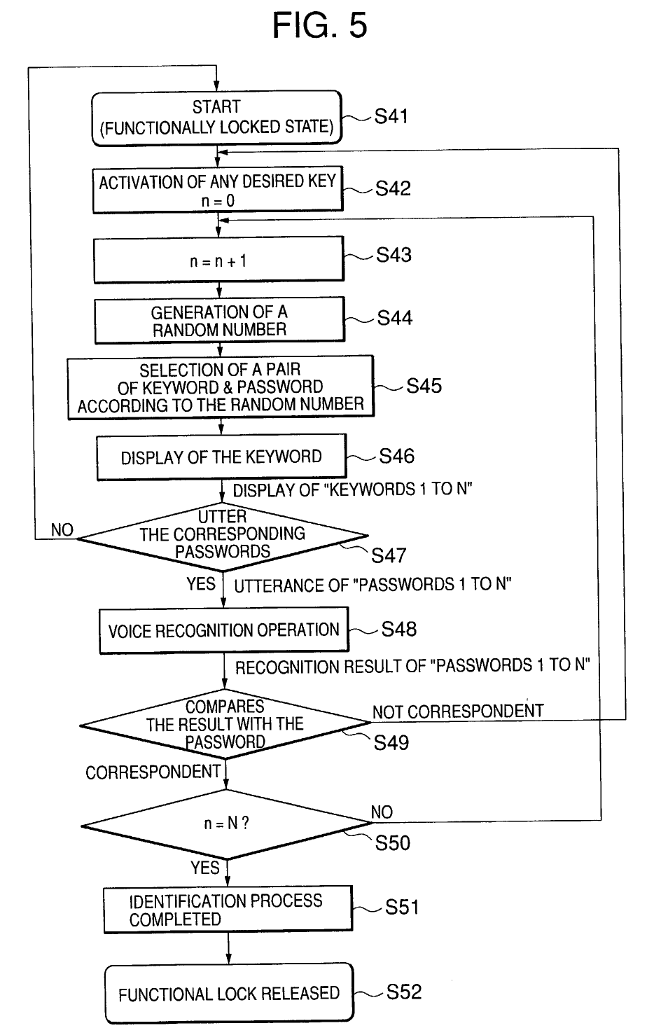

FIG. 5 is a flow chart to show the procedures the cell phone terminal representing the second embodiment will take when the terminal is required to determine, for a given user, whether he/she is an authorized user, based on the voice input from the user. Although the procedures the cell phone terminal of the second embodiment will take with regard to the user identification based on the voice input from the user are basically the same with those of the cell phone terminal of the first embodiment, the former is different from the latter in that a number of pairs of keyword and password are randomly selected as mentioned above.

The cell phone terminal of the second embodiment is also “functionally locked” at the start of its operation as shown in FIG. 5, and then a user can not exploit any function of the terminal as in the cell phone terminal of the first embodiment.

During this state, whenever any desired key of a key input portion 5 is depressed at step S42, key input portion 5 informs a control portion 1 of a key being depressed. Immediately, control portion 1 renders a parameter to zero (initialization), the parameter representing the number of comparison operations which will be described later. Then, the process proceeds to step S43 where n is incremented by one (n<--n+1),.

On receipt of the information of a key being depressed, control portion 1 sends a specified start signal to a. random number generator 8, to activate it. As a consequence, control portion 1 receives a random number generated by the random number generator 8 (step S44). At the succeeding step S45, control portion 1 selects, according to the random number it has received from the random number generator 8, N pairs of keyword and password (for example, “keywords 1 to N” and “passwords 1 to N”) from among multiple pairs of keyword and password previously registered in a memory portion 7.

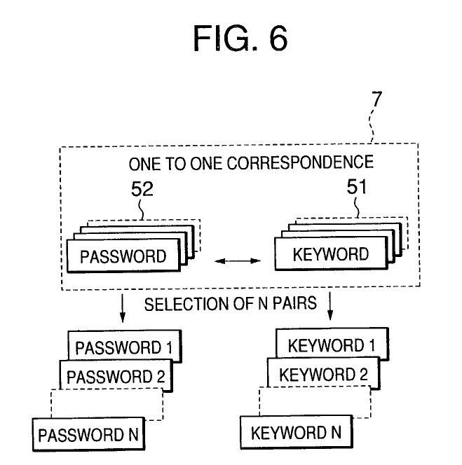

FIG. 6 is a diagram to schematically show the manner how N pairs of keyword and password are selected from the memory portion 7 (“keywords 1 to N” and “passwords 1 to N” are selected in this particular example as mentioned above) where multiple pairs of keyword 51 and password 52 have been registered.

With this embodiment like the first one, keywords 51 and passwords 52 are arranged in a one-to-one corresponding manner in the memory portion 7, and control portion 1 selects N pairs of keyword and password according to a random number obtained from the random number generator 8, from among them.

After having selected paired keywords and passwords as above, at step S46, control portion 1 causes, out of “keywords 1 to N,” firstly “keyword 1” to be displayed in the form of a string of characters legible to the user, and prompts the user, as in the first embodiment, to utter the password paired with “keyword 1” on display.

At step S47, control portion 1 determines whether the user uttered the password paired with “keyword 1” on display. In the same manner as in the first embodiment, on the part of the user, he/she reminds him/herself of “password 1” paired with “keyword 1,” and says it aloud.

The voice input from the user is captured by a microphone 2, and transmitted as a voice signal to a voice processing portion 3 where it is converted into a digital signal, to be fed into a voice recognition portion 4. On receipt of the digital signal, the voice recognition portion 4 performs a specified voice recognition operation on the signal, such that the voice input fed to microphone 2 from outside of the cell phone terminal is converted into a code (conversion operation) (step S48). If control portion 1, however, finds there occurs no voice input (or determines the user gives no voice response) at step S47, the process returns to the first step, and the cell phone terminal enters anew into a “functionally locked state” to remain there.

The user's voice input converted into a code via the voice recognition operation, is used at the subsequent step S49 for determining whether it gives a match with the registered code of “password 1” selected at step S45. If the current voice recognition result gives a sufficient match with the registered code of “password 1,” control portion 1 determines the call is made from an authorized user of the terminal, as far as “keyword 1” is concerned.

Then, at step S50, control portion 1 checks whether the aforementioned parameter n is equal to the previously set number to which comparison should be repeated, and when it finds the n is in short of the set number, it returns the process to step S43, and increments n by one (1). More specifically, when comparison has been completed for a pair of “keyword 1” and “password 1,” comparison shifts to the next pair of “keyword 2” and “password 2,” in accordance with n being incremented by one.

Then, for the second pair of “keyword 2” and “password 2,” the same comparison operation as was done for the first pair is repeated at steps S43 to S49, until n=N at step S50. In other words, the procedures taken at steps S43 to S49 are repeated N times until comparison is made for Nth pair of “keyword N” and “password N.”

When it is determined at step S50 that n=N, comparison has been completed for the first to Nth pairs of “keyword” and “password,” and thus user confirmation (identification) operation completes at step S51. Stated briefly, when comparison has been achieved for the N pairs in question, and perfect match confirmed, the user identification operation is completed. Then, control portion 1 releases a functional lock of the terminal at step S52, and thereafter the functions of the terminal become available for use.

If it is found that a voice recognition result does not agree with the characteristic of a corresponding password previously registered, control portion 1 returns the process to step S42, and waits for the user's pressing a key anew. On the other hand, when the process returns to step S42, control portion 1 initializes again the parameter n (representing the number of comparisons to be repeated) by rendering it to “0.” Therefore, if the two counterparts in question are found not to coincide with each other, the renewed series of comparison will always start from the first pair of “keyword 1” and “password 1.”

As described above, according to the second embodiment, because a number of pairs of keyword and password are randomly selected from among multiple pairs of keyword and password, and comparison is repeated for all the selected pairs to check the user's identity, it will be more difficult for a third party to decipher the password than is possible with the first embodiment where the user identification is based on the comparison of a single pair of keyword and password. This procedure makes it possible to achieve user identification more precisely and safely, and under a stricter secrecy.

This method for user identification comprising selecting a number (N) of pairs of keyword and password, and checking the user identity by repeating comparisons N times for those pairs, ensures high security against, for example, deliberate invasion to the terminal through the use of likely pairs, and introduces a user identification function capable of highly precisely confirming the identity of the user.

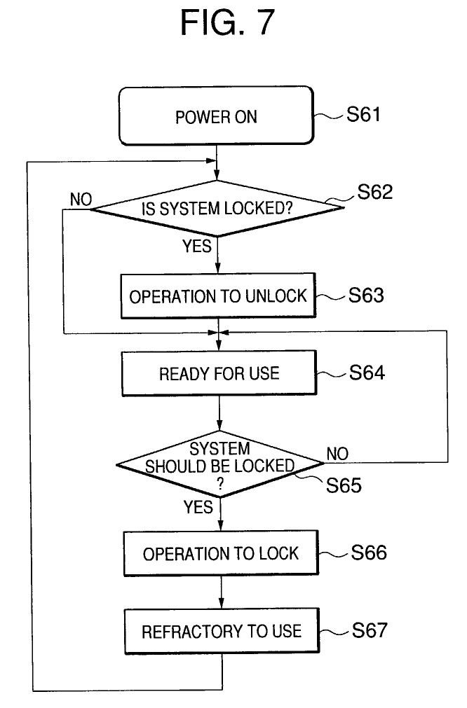

Now, detailed description will be given about the relationship between the operation for user identification according to this invention given above in relation to embodiments 1 and 2, and the actions taken by a cell phone terminal. FIG. 7 is a flow chart to show how the operation necessary for user identification should be positioned in a series of actions of a cell phone terminal. At step S61 of the figure, power to the terminal is switched ON, and at the subsequent step S62, it is checked whether the terminal is in a so-called “locked state.”

If a user wants to release the locked state of the terminal, he/she performs an “unlocking” operation at step S63. The above user identification technique disclosed by the present invention may be applied for the unlocking operation. To put it specifically, if the user utters a password to be paired for a keyword on display, and it is confirmed based on the voice input recognition result that the password is correctly given for the keyword on display, verification of the user's identity is completed and the terminal is “unlocked.”

Consequently, the terminal becomes ready for use (step S64), and the user can freely use the terminal for a desired purpose including conversation. If it is determined at step S62 that the terminal is not in a locked state, the user can freely use the terminal without resorting to the unlocking operation.

If the user wants to shift a state of the terminal where it is ready for use to another where it is locked (YES at step S65), the user may make a specified key input operation, by depressing buttons (ten keys and others), or enter a password at step S66. Then, the terminal becomes refractory to use at step S67. In subsequent uses, these actions and operations are repeated as needed. The operation for switching OFF power to the terminal may be introduced at any step shown in the flowchart of FIG. 7.

If the user identification operation according to this invention is introduced for determining a time when the terminal should be unlocked, it is impossible for others except for those who know a right password to a given keyword, to reach a key to open the lock. Therefore, it is possible to securely prevent the theft of personal data stored in the terminal.

Not to mention, the electronic system to which the user identification method of this invention can be applied is not limited only to cell phone terminals, but may include other communication systems and terminals, and electronic equipment. This invention is not limited to the first and second embodiments, but may be modified in various manners as long as the modifications do not depart from the concept of this invention. Some modified examples of the first and second embodiments will be given below.

### MODIFIED EXAMPLE 1

With the above first and second embodiments, plural keywords and passwords are registered into the memory portion 7 by an authorized user of the terminal. However, of those keywords and passwords, the keywords may be registered by a manufacturer or a distributor of the terminal during manufacture (or at a time when the terminal is shipped or sold), while passwords to be paired with the keywords may be registered by an authorized user of the terminal. Through this arrangement it is possible to relieve the user of a burden involved in the registration of both keywords and passwords, and to simplify the operation for registration.

For this arrangement to be implemented, the terminal may be configured such that control portion 1 checks the memory portion 7 whether there is any vacant area in the portion, and when it finds there is any, the terminal enters into a mode under which the user can enter passwords to fill the vacancy. In other words, if the terminal finds at least one keyword registered, it enters into the user identification operation, whereas if it finds no keyword registered, it may make itself available to any user currently in contact with it. Moreover, the terminal may be configured in such a way as to allow, while the terminal is operable (for example, terminal is at step S64 of FIG. 7), the user to change or update passwords.

If it be assumed that the process shifts to registration operation according to the current state of data writing into the memory portion 7, the process shown in FIG. 7 is introduced on the premise that a keyword has been registered.

### MODIFIED EXAMPLE 2

The above first and second embodiments are configured such that keywords are presented on the display portion 6 in a form allowing visibility for a user, and the user viewing the keywords on display is prompted to utter passwords paired with the keywords. The terminal may be equipped with an additional function whereby the terminal can send a voice message stating, for example, “Utter a password to be paired with the keyword on display,” in addition to displaying the keyword. Through this arrangement it is possible to prevent the user from being unduly confused in operation of the terminal which might otherwise result during the initial manipulation of the terminal.

The terminal may be equipped with a still other function whereby the terminal can deliver, for example via a speaker installed in the terminal, an audible sound representing the keyword. This arrangement will make the terminal more user-friendly because then the terminal will become convenient for use particularly to visually handicapped users.

### MODIFIED EXAMPLE 3

The cell phone terminal representing the second embodiment is configured such that, whenever user identification is required, n (n=N) time comparisons are made for N pairs of keyword and password. However, the configuration may be modified such that a few pairs can be selected for voice recognition operation (user identification) out of the N pairs upon the demand and specification from the user, in case the user encounters with a situation where the urgent use of the terminal is required. Even when the terminal is configured as above, it is possible with the present user identification method to increase the freedom of user identification operation upon the user's request without encroaching on the precision of identification.

### MODIFIED EXAMPLE 4

The above second embodiment is configured such that, whenever user identification is required, N time comparisons are made for N pairs of keyword and password, and only after the voice recognition result and the registered code of password have been found to coincide with each other for all the pairs compared, the user, identification operation is completed. However, the configuration is not limited to this. The user identification may be based on a right answer ratio: if a user on the terminal can give a certain number of right passwords (for example, two or three right passwords) to keywords displayed, and the ratio of right passwords is equal to or higher than a predetermined level, it is determined that the user is one of authorized users. This will contribute to the speeding-up of the user identification operation.

### MODIFIED EXAMPLE 5

The above first and second embodiments are configured such that, whenever it is determined that the voice recognition result is not in agreement with the registered code of password, the process returns to a step where the terminal waits for the user's renewed depression of any desired key. However, the configuration may be modified as follows: the decisions of the user's giving a wrong answer are counted; and as soon as the count is equal to or high than a predetermined level, the user identification operation is forcibly discontinued.

This modification may be introduced because a user who gives wrong passwords certain times equal to or higher than a predetermined level, is likely to be an unauthorized user, and thus it is justifiable to discontinue the user identification operation and to keep the terminal unusable to the user (specifically, to put the terminal in a functionally locked state). This configuration will easily prevent the malicious access to the terminal by unauthorized users.

### MODIFIED EXAMPLE 6

The terminal may be configured such that the plural keywords and passwords can be altered at any time by the user owning the terminal. An additional feature may be added to the terminal such that, in case the user forgets passwords paired with keywords on display after repeated alterations of the pairs, the user can confirm the current pairs of keywords and passwords by resorting to a special key operation only accessible to the user. A still other feature may be added such that only when a password is altered, its paired keyword can be checked.

A modification may be introduced such that, in case a user forgets some passwords for a number of keywords on display, a certain criterion is introduced for the user identification: for example, if a user can give four right passwords to five keywords on display, or if a user can give two right passwords in succession, the user is determined to be an authorized user.

### MODIFIED EXAMPLE 7

With the cell phone terminals representing the first and second embodiments, the voice input from a user required for user identification is used to determine whether the user is authorized or not (non-specific identification), and not to determine the identity of the user (specific identification). However, the user identification operation may be introduced for determining the identity of the user. For this purpose, the voice patterns (for example, voice prints, formants, or the like) of authorized users are registered in advance into the memory portion 7, and whenever a voice input is fed by a user (for example, at step S27 of FIG. 3), the voice pattern extracted from the input is compared with the voice patterns previously registered, and it is determined based on the comparison whether the current user is authorized or not.

A feature may be introduced such that, for a single pair out of plural pairs of keyword and password, the password may be registered as a voice pattern for specific identification, while the remaining pairs are used for non-specific identification. Through this arrangement, it is possible to simplify the voice recognition operation for certain users. The technique whereby one can identify a speaker from the speaker's voice is publicly known and thus the explanation thereof will be omitted.

If the process for examining based on audiological features the correspondence between a password to be paired with a keyword on display with a registered password, is combined with the technique for identifying a specific user based on his/her voice input, and the combined function is introduced into a terminal, it will be possible to provide a cell phone terminal which is far more strengthened in its ability to tell authorized users from unauthorized users.

As described above, an electronic system according to the first aspect of this invention comprises a registration means for registering a set of one or more keywords and passwords which correspond one to one with each other; a selection means for arbitrarily selecting a pair of keyword and password from among the registered set of keywords and passwords; a display means for displaying the selected keyword; a voice recognition means for extracting a characteristic of voice fed from outside of the electronic system, using a voice recognition function; and a comparison means for determining whether the characteristic extracted from the voice through voice recognition function corresponds with that of the password initially registered and paired with the displayed keyword, wherein, when the system finds the characteristic under study is in agreement with that of the initially registered password, it admits the current user that has fed the voice is an authorized user of the electronic system. This feature allows user identification to be achieved through simple procedures without requiring complicated key operation from a user, while strictly keeping secret the identification process, and moreover user identification to occur on a simple configuration without requiring the previous registration of personal data.

An electronic system according to a first aspect of this invention further comprises a means for generating a random number, and arbitrarily selects a pair of keyword and password according to a random number from among the registered set of keywords and passwords, and achieves user identification using a password paired with a keyword which is randomly chosen. This arrangement will make it more difficult to predict the likeliness of a given password being chosen, and thus user identification will be achieved more safely, securely and secretly.

More specifically, because the comparison operation is introduced for user identification for every pair randomly selected from among the registered set of keywords and passwords, it will be more difficult for a third party to decipher the identification process than would be possible for a case where no such random process is introduced, and thus more strict and secure user identification will be achieved.

A method for identifying an authorized user according to a second aspect of this invention comprises the steps of registering one or more keywords and passwords which correspond one to one with each other; arbitrarily selecting a pair of keyword and password from the registered set of keywords and passwords; displaying the keyword of the selected pair; extracting a characteristic from voice fed from outside of the electronic system, using a voice recognition function provided to an electronic system; comparing the characteristic obtained through the voice recognition step with that of the password initially registered and paired with the displayed keyword; and admitting, when it is confirmed at the comparison step that the characteristic under study is in agreement with that of the initially registered password, that the current user that has fed the voice is an authorized user of the electronic system. This feature allows the system to securely achieve user identification through a simple procedure, while strictly keeping secret the identification process.

A method for identifying an authorized user according to a second aspect of this invention further comprises the step of generating a random number, whereby one or more pairs of keyword and password are arbitrarily selected from among the multiple pairs of keyword and password for user identification. This arrangement will make it difficult to predict the likeliness of a given password being chosen, and thus user identification will be achieved more safely, precisely and secretly.

While this invention has been described in connection with certain preferred embodiments, it is to be understood that the subject matter encompassed by way of this invention is not to be limited to those specific embodiments. On the contrary, it is intended for the subject matter of the invention to include all alternatives, modifications and equivalents as can be included within the spirit and scope of the following claims.

What is claimed is:

1. An electronic system equipped with a voice recognition means comprising:
means for registering a set of one or more keywords and passwords which correspond one to one with each other;
selection means for selecting any arbitrary pair of keyword and password from among the registered set of keywords and passwords;
display means for displaying the selected keyword;
means for identifying voice fed from outside of the electronic system, using the voice recognition means; and
means for determining based on the comparison with the identification result whether the voice input corresponds with the password paired with the displayed keyword,
wherein, when it is confirmed as a result of said comparison process that the voice input corresponds with the password, a user that has fed the voice input is approved as an authorized user of the electronic system.

2. An electronic system as described in claim 1 wherein the selection means selects any one or more arbitrary pairs of keyword and password from among the registered set of keywords and passwords.

3. An electronic system as described in claim 2 further comprising a means for generating a random number wherein the selection means selects any one or more arbitrary pairs of keyword and password according to a random number.

4. An electronic system as described in claim 3 wherein the comparison process is introduced for all the keywords given in accordance with said selected plural pairs of keyword and password.

5. An electronic system as described in claim 4 wherein, only after it is confirmed based on the comparison process that the voice input corresponds with the password for all the keywords given in accordance with said plural pairs of keyword and password, a user that has given the voice input is approved as an authorized user of the electronic system.

6. An electronic system as described in claim 4 wherein a user that has given the voice input is approved as an authorized user of the electronic system, only after it is confirmed based on the comparison process that the voice input corresponds with the password a specified number of times or more for all the keywords given in accordance with said plural pairs of keyword and password.

7. An electronic system as described in claim 1 wherein the display means gives a visible and/or audible display of the keyword.

8. An electronic system as described in claim 1 wherein the voice recognition means applies voice-based unspecific identification to an unspecified user.

9. An electronic system as described in claim 1 wherein the voice recognition means applies voice-based specific identification to a specified user.

10. An electronic system as described in claim 1 wherein the voice recognition means applies voice-based specific identification to a specified user, in relation with specified keywords out of said selected plural pairs of keyword and password, while it applies voice-based unspecific identification to an unspecified user, in relation with the remaining keywords.

11. A method for identifying an authorized user useful for an electronic system provided with a voice recognition function comprising the steps of:
registering a set of one or more keywords and passwords which correspond one to one with each other;
selecting any arbitrary pair of keyword and password from among the registered set of keywords and passwords;
displaying the selected keyword;
identifying voice fed from outside of the electronic system, using the voice recognition function;
determining based on comparison with the result obtained at the identification step whether the voice input corresponds with the password paired with the displayed keyword; and
approving, only after it is confirmed at the comparison step that the voice input corresponds with the password, a user that has fed the voice input is an authorized user of the electronic system.

12. A method as described in claim 11 for identifying an authorized user wherein the selection step comprises selecting any one or more arbitrary pairs of keyword and password from among the registered set of keywords and passwords.

13. A method as described in claim 12 for identifying an authorized user further comprising a step for generating a random number wherein the selection step comprises selecting any one or more arbitrary pairs of keyword and password according to a random number.

14. A method as described in claim 13 for identifying an authorized user wherein the comparison step is introduced for all the keywords given in accordance with said selected plural pairs of keyword and password.

15. A method as described in claim 14 for identifying an authorized user wherein the identification step comprises approving, only after it is confirmed that the voice input corresponds with the password for all the keywords given in accordance with the plural pairs of keyword and password, a user that has given the voice input is an authorized user of the electronic system.

16. A method as described in claim 14 for identifying an authorized user wherein the identification step comprises approving, only after it is confirmed that the voice input corresponds with the password a specified number of times or more for all the keywords given in accordance with the plural pairs of keyword and password, a user that has given the voice input is an authorized user of the electronic system.

17. A method as described in claim 16 for identifying an authorized user wherein specific identification based on the voice recognition function is applied in relation with specified keywords out of said selected plural pairs of keyword and password, while unspecific identification based on the voice recognition function is applied in relation with the remaining keywords.

18. A program for identifying an authorized user to be installed in an electronic system provided with a voice recognition function, effective for achieving the processes of:
registering a set of one or more keywords and passwords which correspond one to one with each other;
selecting any arbitrary pair of keyword and password from among the registered set of keywords and passwords;
displaying the selected keyword;
identifying voice fed from outside of the electronic system, using the voice recognition function;
determining based on comparison with the result obtained by the identification process whether the voice input corresponds with the password paired with the displayed keyword; and
approving, only after it is confirmed through the comparison process that the voice input corresponds with the password, a user that has fed the voice input is an authorized user of the electronic system.
